(19) United States
(12) Patent Application Publication
(10) Pub. No.: US 2026/0205909 A1
(43) Pub. Date: Jul. 16, 2026

(54) REDIRECTING USER EQUIPMENT TO NON-PUBLIC MOBILE NETWORK

(71) Applicants: Koninklijke KPN N.V., Rotterdam (NL); Nederlandse Organisatie Voor Toegepast-Natuurwetenschappelijk Onderzoak TNO, 's-Gravenhage (NL)

(72) Inventors: Belma Turkovic, Delft (NL); Lucia D'Acunto, Amsterdam (NL)

(21) Appl. No.: 19/137,602

(22) PCT Filed: Dec. 9, 2023
(86) PCT No.: PCT/EP2023/085005

§ 371 Date: Jun. 10, 2025

(30) Foreign Application Priority Data
Dec. 23, 2022 (EP) 22216623

(51) Int. Cl. H04W 36/14; H04W 36/00; H04W 36/32

(52) U.S. Cl. CPC H04W 36/14; H04W 36/0058; H04W 36/322

(57) ABSTRACT

A first system may be provided in a public mobile network and a second system may be provided in a non-public mobile network, which systems may cooperate to selectively redirect user equipment from the public mobile network to the non-public mobile network. Such redirection may be implemented by the first system instructing base station(s) within the coverage area or vicinity of the non-public mobile network to, in turn, instruct user equipment to perform measurements at radio frequencies used by the non-public mobile network. This way, the user equipment may be instructed to listen at the radio frequencies used by the non-public mobile network, and if the user equipment is in the coverage area of the non-public mobile network, the user equipment may switch and connect to the non-public mobile network and thereby benefit from enhanced services and/or additional coverage. Advantageously, it may not be needed for the user to manually search for the non-public mobile network, nor for the user equipment to be already provisioned for the non-public mobile network.

### TECHNICAL FIELD

The invention relates to systems for redirecting user equipment from a public mobile network to a non-public mobile network. The invention further relates to computer-implemented methods performed at the respective systems, to a device representing the user equipment and to a computer-implemented method performed at the device. The invention further relates to a computer-readable medium comprising data for causing a processor system to perform a computer-implemented method.

### BACKGROUND

Recent telecommunication standards provide support for non-public networks (NPN), with a typical example of a non-public network being a private network. Such non-public networks may take various forms, for example as standalone non-public mobile networks (SNPN), referring to a non-public network that is operated by a NPN operator and not relying on network functions provided by a public land mobile network (PLMN), or as public network integrated non-public networks (PNI-NPN), referring to a non-public network which may be deployed with the support of a public network. It is desirable for user equipment (UE) to be able to dynamically switch between public networks and non-public networks, with both types of networks being elsewhere also referred to as ‘mobile’ networks. For example, a non-public mobile network may be deployed at a venue, such as a museum, stadium, conference center or any other cultural, sports or business venue, to offer enhanced services or additional coverage to its visitors. A non-limiting example of enhanced services is a demanding service being enhanced locally, e.g., by providing support for “Video, Imaging, and Audio for Professional Applications” (VIAPA) as described in 3GPP TR 23.700-07.

However, to be able to use the enhanced services or additional coverage, a UE may need to switch to the non-public mobile network when the UE is in the vicinity of the venue or at an event. However, the non-public mobile network may be unaware of the identity of the UE, since the UE may not be subscribed to the non-public mobile network. There are multiple reasons for this. Firstly, it may be difficult to predict that users will visit a specific venue or attend a specific event or to predict the time that the users will be present at the venue or event. As such, it is difficult to pre-provision the UE of the users in advance. Secondly, even if it is ensured that the UE is subscribed to the non-public mobile network, this is unlikely to scale well as the same operator of the non-public mobile network is not likely to organize many (or all) of the events the user wishes to attend. Thirdly, the operator of the non-public mobile network should not depend on users searching for the non-public mobile network on their UE and manually switching themselves to the non-public mobile network since (1) many users might be unaware of the non-public mobile network's presence or (2) the users might not be tech-savvy enough to search for and switch to the non-public mobile network.

### SUMMARY

It is desirable to be able to redirect user equipment from a public mobile network to a non-public mobile network without a need for users to manually search for and switch to the non-public mobile network.

In a first aspect of the invention, a system is provided for redirecting user equipment from a public mobile network to a non-public mobile network, wherein the system is part of the public mobile network. The system may comprise:
a network interface;
a processor subsystem which may be configured to, via the network interface:
   receive a request to redirect user equipment from the public mobile network to the non-public mobile network, wherein the request may identify the non-public mobile network;
   receive location information which may be indicative of a coverage area of the non-public mobile network;
   receive frequency information which may be indicative of one or more radio frequencies used by the non-public mobile network;
   identify at least one base station of the public mobile network which may be located in or within a range of the coverage area of the non-public mobile network; and
   using the at least one base station of the public mobile network, instruct user equipment which may be connected to the at least one base station to perform measurements at the one or more radio frequencies so as to enable the user equipment to connect to the non-public mobile network if the measurements indicate that a connection to the non-public mobile network is possible.

In a further aspect of the invention, a system is provided for redirecting user equipment from a public mobile network to a non-public mobile network, wherein the system is part of the non-public mobile network. The system may comprise:
a network interface;
a processor subsystem which may be configured to, via the network interface:
   send a request to the public mobile network to redirect user equipment from to the public mobile network to the non-public mobile network, wherein the request may identify the non-public mobile network;
   send location information to the public mobile network, wherein the location information may be indicative of a coverage area of the non-public mobile network; and
   send frequency information to the public mobile network, wherein the frequency information may be indicative of one or more radio frequencies used by the non-public mobile network.

In a further aspect of the invention, a device is provided representing user equipment for a mobile network. The device may comprise:
a radio access network interface;
a processor subsystem which may be configured to, when connected to a public mobile network:
   receive a request to perform measurements at one or more radio frequencies which may be used by a non-public mobile network, wherein the one or more radio frequencies may be indicated by frequency information, wherein the frequency information may be received as part of the request or separately;
   in response to the request, perform the measurements; and
   connect to the non-public mobile if the measurements indicate that a connection to the non-public mobile network is possible.

In a further aspect of the invention, a computer-implemented method is provided for redirecting user equipment from a public mobile network to a non-public mobile network. The method may comprise, at the public mobile network:
receiving a request to redirect user equipment from the public mobile network to the non-public mobile network, wherein the request may identify the non-public mobile network; receiving location information which may be indicative of a coverage area of the non-public mobile network;
receiving frequency information which may be indicative of one or more radio frequencies used by the non-public mobile network;
identifying at least one base station of the public mobile network which may be located in or within a range of the coverage area of the non-public mobile network; and
using the at least one base station of the public mobile network, instructing user equipment which may be connected to the at least one base station to perform measurements at the one or more radio frequencies so as to enable the device to connect to the non-public mobile network if the measurements indicate that a connection to the non-public mobile network is possible.

In a further aspect of the invention, a computer-implemented method is provided for redirecting user equipment from a public mobile network to a non-public mobile network. The method may comprise, at the non-public mobile network:
sending a request to the public mobile network to redirect user equipment from to the public mobile network to the non-public mobile network, wherein the request may identify the non-public mobile network;
sending location information to the public mobile network, wherein the location information may be indicative of a coverage area of the non-public mobile network; and
sending frequency information to the public mobile network, wherein the frequency information may be indicative of one or more radio frequencies used by the non-public mobile network.

In a further aspect of the invention, a computer-implemented method may be provided for being performed by a device which represents user equipment of a public mobile network. The method may comprise, by the device:
receiving a request to perform measurements at one or more radio frequencies used by a non-public mobile network, wherein the one or more radio frequencies may be indicated by frequency information, wherein the frequency information may be provided as part of the request or separately;
in response to the request, performing the measurements; and
connecting to the non-public mobile if the measurements indicate that a connection to the non-public mobile network is possible.

In a further aspect of the invention, a transitory or non-transitory computer-readable medium may be provided comprising data representing a computer program, the computer program comprising instructions for causing a processor system to perform any of the computer-implemented methods as described in this specification.

In accordance with the above measures, a first system may be provided in the public mobile network and a second system may be provided in the non-public mobile network, which systems may cooperate to redirect user equipment (UE) from the public mobile network to the non-public mobile network. The first system may in the following also be referred to as a ‘public network system’ and the second system as a ‘non-public network system’. The UE, meaning one or each of a plurality of UE, may be a subscriber to the public mobile network or otherwise be allowed to roam via the public mobile network and, before the redirection, be connected to the public mobile network, but typically not be provisioned to make use of the non-public mobile network, for example, by lacking a subscription to the non-public mobile network. To enable the UE to nevertheless connect to the non-public mobile network, for reasons as elucidated elsewhere in this specification, the UE may be instructed to perform measurements at the radio frequencies used by the non-public mobile network.

These instructions may be sent by the public network system, for example, at the request of the non-public network system, and may be generated based on information characterizing the non-public mobile network. In turn, this information may be made available by the non-public network system to the public network system and may comprise an identifier of the non-public mobile network, a location of the non-public mobile network (e.g., in the form of a geolocation or coverage area) and may indicate one or more radio frequencies at which base station(s) of the non-public mobile network operate. Based on the supplied information, the public network system may selectively redirect UE to the non-public mobile network, in that only UE, which may be connected to base stations of the public mobile network which are located in a coverage area or a vicinity of the non-public mobile network, may be redirected.

More specifically, the selective redirection may be implemented by the public network system identifying which of the public network's base stations are within the coverage area, or at least within a vicinity of the non-public mobile network, and by providing instructions to only those UE which are connected to these base stations, and in some embodiments only to a subset of those UE. The location of a base station of the public mobile network may thus be used as an indication of the location of UE, which are connected to the base station. This way, it may be avoided that UE which are (far) outside of the coverage area of the non-public mobile network are redirected, which may otherwise result in unnecessary measurements being performed by UE and/or there being unnecessary internal data communication within the public mobile network. In addition, by using the location of the base station to which the UE is connected to as an indication of the location of the UE, it is not needed to otherwise determine the (precise) location of UE, which may address privacy concerns and reduce unnecessary data communication.

The redirection itself may be implemented by the public network system instructing the base station(s) within the coverage area or vicinity of the non-public mobile network to in turn instruct the user equipment to perform measurements at the one or more radio frequencies used by the base stations of the non-public mobile network. This way, a UE may be instructed to listen at the radio frequencies used by the non-public mobile network, which it otherwise may not do. Such measurements may represent a prerequisite for the UE to be able to actually switch to the non-public mobile network. Namely, on the basis of the measurements, it may be determined whether the UE is in range of the non-public mobile network or not, and if it is within range, the UE may switch and connect to the non-public mobile network, for example after receiving an instruction to do so or based on internal decision logic which implements such a switch.

As a UE within the coverage area of the non-public mobile network may be automatically instructed to perform the measurements, it may not be needed for a user to manually search for the non-public mobile network. This may greatly increase the potential usage of non-public mobile networks for which a UE may not already be provisioned. Indeed, it is likely that a UE may not be provisioned to make use of many instances of non-public mobile networks as they may only have a limited coverage area and/or are only temporary, which may make it difficult to predict which UE will be within the coverage area of the non-public mobile network and therefore may make it difficult to predict which UE need to be provisioned in advance. Therefore, based on the above measures, a UE may still connect to the non-public mobile network if it is within its coverage area to benefit from enhanced services and/or additional coverage area.

The following embodiments may relate to the system which is part of the public mobile network and the computer-implemented method performed at the public mobile network but may also denote corresponding limitations of the system which is part of the non-public mobile network and the computer-implemented method performed at the non-public mobile network and of the device representing user equipment and the computer-implemented method performed at the device.

In an embodiment, the processor subsystem may be configured to, using the at least one base station:
receive measurement data from the user equipment, wherein the measurement data comprises the measurements performed by the user equipment;
analyze the measurements to determine if the connection to the non-public mobile network is possible, and if so, instruct the user equipment to connect to the non-public mobile network.

The public network system may obtain the measurement data from the user equipment and analyze the measurement data to determine if a UE can connect to the non-public mobile network, e.g., with a sufficient connection quality. If so, the public network system may instruct the UE via its base station to connect to the non-public mobile network. In such an embodiment, the UE may not need to decide itself whether to connect to the non-public mobile network but may rather carry out and report the measurements, which is by itself prior-art functionality, and then carry out the instruction to connect to the non-public mobile network. It may thus not be needed to modify a prior art UE to be able to decide itself whether to connect to the non-public mobile network. In addition, by taking such a decision within the network, more control may be retained over the switching of UE to the non-public mobile network.

In an embodiment, the processor subsystem may be configured to, using the at least one base station, instruct the user equipment to switch to an access mode for connecting to the non-public mobile network if the measurements indicate that the connection to the non-public mobile network is possible. Some types of non-public mobile networks, such as standalone non-public mobile networks, may necessitate a switch in access mode to be able to connect to the non-public mobile network. In accordance with the above measures, the UE may be instructed to switch access mode, e.g., to a non-public mobile network access mode, if the network decides that the UE is to be redirected to the non-public mobile network. It may thus not be needed to modify a prior art UE to be able to switch access mode itself to connect to the non-public mobile network. In addition, by taking such a decision within the network, more control may be retained over the switching of UE to the non-public mobile network.

In an embodiment, the processor subsystem may be configured to receive time information which is indicative of a start time at which the user equipment is to be redirected to the non-public mobile network, and instruct the user equipment at the start time or at a time which is selected based on the start time. The non-public mobile network may be temporary or only semi-permanent and may thus not be operational at all times, or it may, in general, not be desirable to redirect UE to the non-public mobile network at all times. To take this into account, the UE may only be redirected to the non-public mobile network starting from a specified time, which may be, for example, the time at which the non-public mobile network becomes operational or when a particular event starts, etc. In some embodiments, the redirection may only be active during a time window which may be defined by a start time and a stop time, e.g., to account for a non-public mobile network stopping its operation or a particular event stopping, etc.

In an embodiment, the processor subsystem may be configured to instruct the user equipment using the at least one base station by provisioning the at least one base station to send corresponding instructions to the user equipment. The instructions provided to the UE may thus be sent via the base station(s) of the public mobile network, which may be provisioned to do so. In other words, the public network system may provision its base station(s) to send instructions to the UE relating to the redirection. This may be advantageous since a base station is able to directly communicate with the connected UE and is, therefore, able to directly instruct the UE, which is in the coverage area or vicinity of the non-public mobile network. Advantageously, it may not be needed to generate instructions for individual UE in the public mobile network upstream of the base station(s), which reduces the amount of internal data communication within the public mobile network.

In an embodiment, the provisioning may comprise sending at least the frequency information to the at least one base station to enable the at least one base station to instruct the user equipment to perform the measurements at the one or more radio frequencies. As part of the provisioning of its base station(s) in the coverage area or vicinity of the non-public mobile network, the public network system may provide the necessary information to its base station(s) to be able to instruct the UE, such as the one or more radio frequencies at which the UE is to perform measurements.

In an embodiment, the processor subsystem may be configured to, in response to a request to stop redirecting the user equipment to the non-public mobile network, provision the at least one base station to stop sending instructions to the user equipment. The non-public mobile network may be temporary or only semi-permanent and may thus not be operational at all times, or it may, in general, not be desirable to redirect UE to the non-public mobile network at all times. To take this into account, the redirection of UE to the non-public mobile network may be stopped, e.g., to account for a non-public mobile network stopping its operation or a particular event stopping, etc.

In an embodiment, the processor subsystem may be configured to send a report to the non-public mobile network, wherein the report comprises at least one of:
a number of user equipment which is redirected to the non-public mobile network;
an identifier of user equipment which is redirected to the non-public mobile network;
a duration of a connection of user equipment to the non-public mobile network; and
charging information associated with the redirecting of the user equipment to the non-public mobile network.

Such reporting may, for example, be used for charging purposes.

In an embodiment, the request may be received from the non-public mobile network or wherein the request may be an internal request from the public mobile network. The request to redirect UE may originate from the non-public mobile network itself, e.g., from the non-public network system or another entity within the non-public mobile network, but may also be an internal request from the public mobile network, for example, if it is desired to offload some UE to the non-public mobile network for capacity reasons or to extend the coverage of the public mobile network.

The following embodiments may relate to the system which is part of the non-public mobile network and the computer-implemented method performed at the non-public mobile network but may also denote corresponding limitations of the system which is part of the public mobile network and the computer-implemented method performed at the public mobile network and of the device representing user equipment and the computer-implemented method performed at the device.

In an embodiment, the processor subsystem may be configured to send one or more of a group of:
a start time at which the user equipment is to be redirected to the non-public mobile network,
a stop time after which the user equipment is not to be redirected to the non-public mobile network,
a reporting interval indicating at which interval the public mobile network is to report on redirection of the user equipment,
a reporting type indicating a type of the reporting,
identification information identifying a group of user equipment which is to be redirected to the non-public mobile network,
   to the public mobile network.

The start time and the stop time may together define a time window or time interval during which UE is to be redirected. Alternatively, either the start time or the stop time may be sent. In the latter case, the redirection may begin immediately and stop at the indicated stop time, while in the former case, the redirection may start at the indicated start time and continue, e.g., until a request is received to stop redirection.

The reporting type may indicate a type of reporting, e.g., periodic, none, unidirectional, directional, or upon request, while the reporting interval may be a further optional parameter indicating how often the reporting is to be carried out for some types of reporting, e.g., periodic. Another aspect is that the UE to be redirected may not only be selective in terms of location but may also be limited in other ways to a particular group of UE. For example, the non-public network system may obtain a list of UE which it wishes to allow access to the non-public mobile network. This list may, for example, be comprised of identifiers of the UE (e.g., in the form of phone numbers) and may cause the public network system to redirect only those UE that are within the coverage area or vicinity of the non-public mobile network (e.g., by only the base stations in that coverage area or vicinity being provisioned to redirect UE), but in addition only those UE that are included in the list, or in general, part of the group. This may allow a non-public mobile network to limit the access to its network to only select UE, e.g., those which have tickets to an event or venue and which registered their phone numbers in advance.

In a further aspect of the invention, a mobile network is provided comprising a system for redirecting user equipment as described in this specification. For example, a public mobile network may be provided comprising the public network system, or a non-public mobile network may be provided comprising the non-public network system.

The following embodiments may relate to the device representing user equipment and the computer-implemented method performed at the device but may also denote corresponding limitations of the system which is part of the public mobile network and the computer-implemented method performed at the public mobile network and of the system which is part of the non-public mobile network and the computer-implemented method performed at the non-public mobile network.

In an embodiment, the processor subsystem may be configured to, before connecting to the non-public mobile network, switch to an access mode for connecting to the non-public mobile network, for example, in response to an instruction received from the public mobile network. Some types of non-public mobile networks, such as standalone non-public mobile networks, may necessitate a switch in access mode by the UE to be able to connect to the non-public mobile network. In accordance with the above measures, the UE may switch access mode, e.g., to a non-public mobile network access mode, for example, in response to an instruction from the public mobile network. This way, the UE is enabled to connect to the non-public mobile network. In particular, if the UE is configured to switch access mode in response to an instruction sent by the public mobile network, the public operator may control to which non-public mobile network the UE connects, which may provide security advantages as it may be avoided that the UE connects to a “malicious” non-public mobile network.

In an embodiment, the processor subsystem may be configured to, after disconnecting from the non-public mobile network, switch to an access mode for connecting to the public mobile network. If a switch in access mode is needed to connect to the non-public mobile network, another switch in access mode may be needed to again connect to the public mobile network. The device may be configured to perform such a switch back to the public mobile network access mode, e.g., upon disconnecting or being disconnected from the non-public mobile network, to be able to reconnect to the public mobile network. This way, it may be ensured that the device can reconnect back to the public mobile network, for example after being only temporarily connected to the non-public mobile network. This is advantageous since many types of non-public mobile networks may only have a limited coverage area and/or are only temporary. It is thus desirable for the device to be able to switch back to the public mobile network. It may also be avoided that the UE connects to “malicious” non-public mobile network upon being disconnected from the earlier non-public mobile network, which may otherwise happen if the UE remains in the non-public mobile network access mode and continues searching for non-public mobile networks.

In an embodiment, the processor subsystem may be configured to:
send the measurements to the public mobile network; and
connect to the non-public mobile network in response to a request from the public mobile network to connect to the non-public mobile network.

In accordance with this embodiment, the public network system may decide if the UE is to switch to the non-public mobile network. By taking such a decision within the network, more control may be retained over the switching of UE.

In an embodiment, the processor subsystem may be configured to analyze the measurements to determine if the connection to the non-public mobile network is possible, and if so, connect to the non-public mobile network. By taking such a decision within the device, the device may autonomously decide to switch to the non-public mobile network, which avoids the need for external data communication. In addition, in its decision, the device may make use of data which may not be directly accessible to the network but which may be accessible to the device, for example the device's exact location or user preferences (e.g., stored in the device or sim card) or the like.

It will be appreciated by those skilled in the art that two or more of the above-mentioned embodiments, implementations, and/or aspects of the invention may be combined in any way deemed useful.

Modifications and variations of any one of the systems or devices, computer-implemented methods, and/or computer programs, which correspond to the described modifications and variations of another one of these systems or devices, computer-implemented methods, and/or computer programs, or vice versa, may be carried out by a person skilled in the art on the basis of the present description.

### BRIEF DESCRIPTION OF THE DRAWINGS

These and other aspects of the invention are apparent from and will be elucidated with reference to the embodiments described hereinafter. In the drawings,

FIG. 1 shows user equipment (UE) which are subscribers of a public land mobile network (PLMN) being in a coverage area of a non-public network (NPN)

FIG. 2 shows a UE of the PLMN switching from the PLMN to the SNPN;

FIG. 3 shows the redirection of the UE to the SNPN, which involves a provisioning phase, an active phase, a reporting phase, and a cleanup phrase;

FIG. 4 shows a message exchange in the provisioning phase;

FIG. 5 shows a message exchange in the active phase;

FIG. 6 shows a message exchange in the reporting phase;

FIG. 7 shows a message exchange in the cleanup phase;

FIG. 8 shows a processor system which may be exemplary for a system, or a UE as described in this specification;

FIG. 7 shows a non-transitory computer-readable medium comprising data;

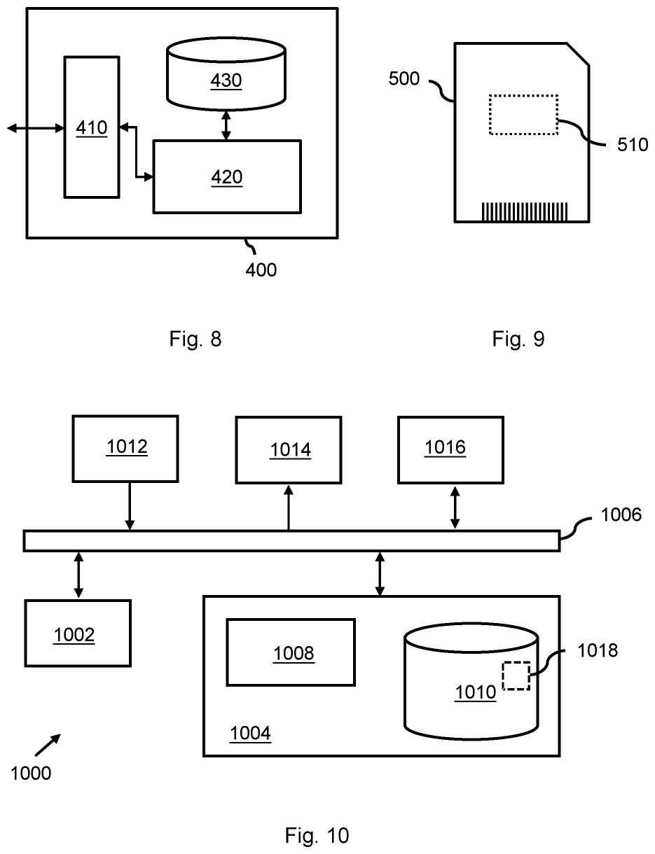

FIG. 8 shows an exemplary data processing system.

It should be noted that items which have the same reference numbers in different figures, have the same structural features and the same functions, or are the same signals. Where the function and/or structure of such an item has been explained, there is no necessity for repeated explanation thereof in the detailed description.

### REFERENCE SIGNS LIST

The following list of references and abbreviations is provided for facilitating the interpretation of the drawings and shall not be construed as limiting the claims.
5GC 5G core
NPN non-public mobile network
SNPN standalone non-public mobile network
PLMN public land mobile network
UE user equipment
1-43 messages/steps
100 public land mobile network 5G core
110 public land mobile network base station
200 non-public network 5G core
210 non-public network base station
220 coverage area of non-public network
300 user equipment
400 system
410 network interface
420 processor subsystem
430 data storage
500 non-transitory computer-readable medium
510 stored data
1000 exemplary data processing system
1002 processor
1004 memory element
1006 system bus
1008 local memory
1010 bulk storage device
1012 input device
1014 output device
1016 network adapter
1018 application

### DESCRIPTION OF EMBODIMENTS

The following embodiments are described in the context of a 5G telecommunications network adhering to one or more ETSI NFV and related standards. However, the concepts described in the following embodiments may equally apply, mutatis mutandis, to any other type of telecommunication standard which provides for public mobile networks and non-public mobile networks for user equipment.

For reasons of conciseness, the following may refer to public mobile works simply as public networks or by the acronym PLMN, and to non-public mobile networks as non-public networks or private networks or by the acronym SNPN, which refers to the specific example of a standalone non-public network. However, this is not a limitation, as the claimed measures may equally apply to other types of non-public networks, such as public network integrated non-public networks (PNI-NPN).

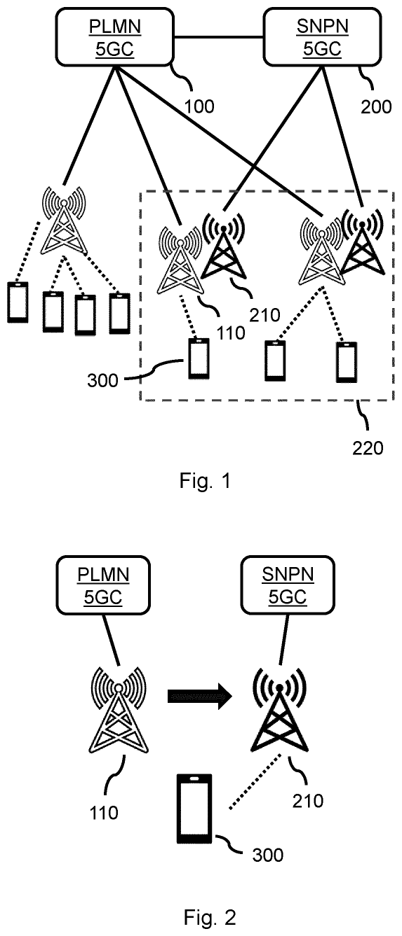

FIG. 1 shows user equipment UE 300, which is located in a coverage area 220 of a standalone non-public mobile network SNPN. The SNPN is shown in FIG. 1 in the form of a network core 200 and one or more base stations 210. The network core 200 may be a 5G network core (‘5GC’), but may also be a later generation network core, e.g., 6^{th} generation or later. FIG. 1 further shows a public land mobile network PLMN, which is also shown in the form of a 5G network core 100 and one or more base stations 110. In the example of FIG. 1, the coverage area 220 of the non-public network SNPN at least partially overlaps with a coverage area of the public network, for example, as the PLMN may have base stations 110 in the coverage area 220 of the SNPN. The UE 300 may be a subscriber or at least be able to roam via the PLMN but may typically not be a subscriber to the SNPN.

In FIG. 1, the UE 300 is shown to be connected to the PLMN via a base station 110 while being in the coverage area 220 of the SNPN. It may nevertheless be desirable for the UE 300 to connect to the SNPN, for example temporarily while remaining in its coverage area 220, for example, to make use of enhanced services and/or additional coverage which may be provided by the SNPN to the UE 300.

FIG. 2 illustrates a result of the UE 300 switching from the PLMN to the SNPN as the UE 300 is now connected to a base station 210 of the SNPN. A method for the UE switching from a PLMN to a SNPN may be known per se. Namely, a user of a UE may search for the SNPN using the UE's user interface, for example by requesting the UE to show all available mobile networks, and manually instruct the UE to connect to the SNPN, for example by selecting the SNPN from a list of found mobile networks.

However, it would be desirable to enable UE at a particular location to be redirected to an SNPN without the manual involvement of a user. The following technical measures may make use of a PLMN, and in particular the PLMN to which the UE is connected to, to redirect the UE to a SNPN. It will be understood that this may involve a business agreement between the operators of the PLMN and the SNPN being in place, e.g., to incentivize the operator of the PLMN to redirect its subscribers to the SNPN. However, such a business agreement is not required to technically carry out the redirection and therefore is not an (essential) feature of the invention. It is noted that a need for business agreements may also reduce the possibility that the UE would be redirected to a malicious SNPN network as the PLMN may not be incentivized to do SO.

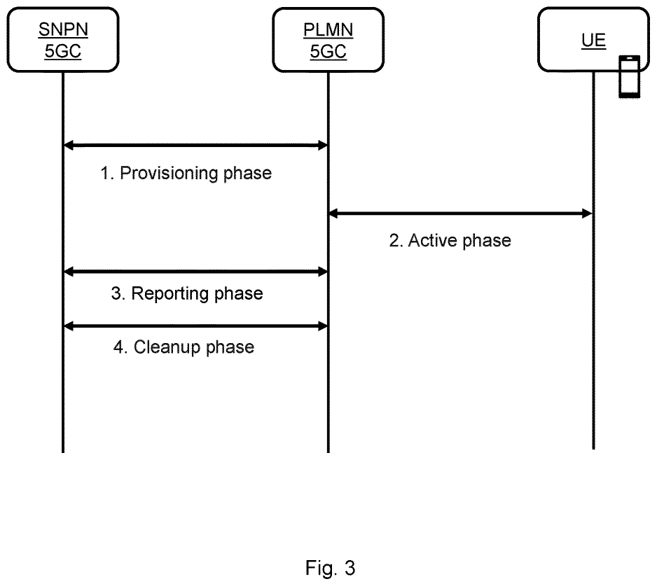

FIG. 3 illustrates several phases of the redirection of the UE to the SNPN, which may include a provisioning phase 1, an active phase 2, a reporting phase 3, and a cleanup phase 3. For each of these phases, the arrows in FIG. 3 identify the entities involved, being the SNPN (shown for simplicity's sake only by way of its 5G core), the PLMN (also only shown by way of its 5G core) and the UE to be redirected.
1. Provisioning phase. The provisioning phase may be used to exchange information between the PLMN and the SNPN, for example, to inform the PLMN about the SNPN's location and capabilities. Based on the exchanged information, the PLMN may provision its base stations, e.g., its gNodeBs in the example of 5G PLMN, to redirect UE to the SNPN.
2. Active phase. The active phase may involve the redirection of the UEs to the SNPN via the base stations of the PLMN.
3. Reporting phase. The reporting phase may involve a reporting from the PLMN to the SNPN, or from the SNPN to the PLMN, or in both directions. Via such reporting, the PLMN and/or the SNPN may obtain a better overview of the redirect process and the costs, e.g., in technical and/or financial terms, resulting from the redirection of the UEs to the SNPN. It is noted that this phase may be performed together with the active phase, but additionally or alternatively also after completion of the active phase.
4. Cleanup phase. In the cleanup phase, the PLMN may be informed that the SNPN is no longer active. Additionally, charging records may be exchanged between the SNPN and the PLMN, for example detailing the number of redirected PDU sessions.

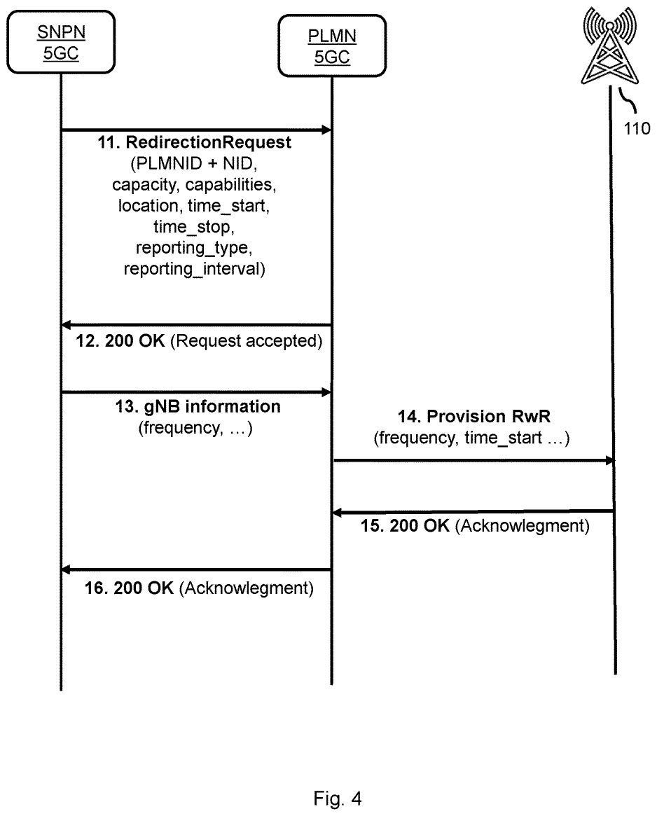

These phases are described in more detail with reference to FIGS. 4-7, with each figure showing an exchange of information for a respective phase. In these examples, the base stations of the SNPN and PLMN are shown as gNodeBs (gNBs). However, it is noted that the steps of the redirection of the UE may also be partitioned in other phases or not explicitly or implicitly partitioned in phases at all. It will be further appreciated that in this description, the mere reference to certain steps or phases being ‘optional’ does not imply that other steps or phases which are not explicitly labeled as optional are required if they are, in fact, from a technical perspective, also optional.

FIG. 4 shows a message exchange in the provisioning phase. In this and the following figures, the messages in the figure may be numbered, with the same numbering being used in the accompanying description of the message exchange.

The message exchange in FIG. 4 may involve the following steps:
11. The SNPN's 5GC may send a RedirectionRequest message to the PLMN 5GC. This RedirectionRequest may carry information including, but not limited to, one or more of: an identifier of the SNPN (which may take the form of a PLMN ID and an additional network identifier NID), an indication of the SNPN's capacity, capabilities, location, a start time and/or stop time of the redirection, a requested reporting type (e.g., periodic, none, unidirectional, directional, or upon request) and a reporting interval. With this request, the SNPN may request the PLMN to redirect UEs in a particular location and in some examples for a particular time frame (e.g., defined with time_start and time_stop parameters) to the SNPN. Optionally, the request may specify the quality of service (QOS) or network slices that the SNPN will or is able to provide for the UE's PDU sessions.
12. The PLMNs 5GC may respond to the request with a 200 OK (Request accepted) message if the PLMN decides to fulfill the request. If the PLMN returns an error, the redirection procedure may stop at this step and without continuing to any of the next phases.
13. The SNPN's 5GC may send a message to the PLMN with information on the SNPN's gNBs, for example, by providing frequency information specifying the frequencies used by the SNPN's gNBs. This step may only be executed after the PLMN accepts the redirection request to ensure that internal SNPN's information (e.g., used frequencies) is not shared with a non-cooperating PLMN. Optionally, in addition to frequency information, also other information may be provided by the SNPN's 5GC to the PLMN, such as location information which may be indicative of the geographic location of individual gNBs.
14. The PLMN's 5GC may send a message to at least some of its gNBs 110 which may take the form of: Provision RwR (frequency, time_start, time_stop ...) in which ‘RwR’ stands for ‘Release with Redirect’. With this message, the PLMN may provision its gNBs to redirect the UEs at the SNPN's location to the SNPN. The provisioning of the gNBs may be selective, in that only the gNBs at or in the vicinity of the location specified in the redirection request may be provisioned, thereby minimizing the number of provisioning messages in the PLMN. Moreover, if the start_time is specified, the provisioned information may not be applied, and thus actively used, until that point in time.
15. The PLMN's gNBs 110 may respond with a 200 OK (Acknowledgment) message to inform the PLMN's 5GC.
16. The PLMN's 5GC may send a 200 OK (Acknowledgment) message to SNPN's 5GC. Namely, after the PLMN's gNBs are provisioned, the PLMN's 5GC may inform the SNPN's 5GC that the PLMN is prepared to enter the next phase, e.g., the active phase, as explained in the following.

With continued reference to step 11, it is noted that the location of the SNPN may be indicated in various ways to the PLMN, for example as a geolocation defined by a latitude and a longitude, as a geographical area defined by a latitude, longitude, and radius, as a geographical area defined by a plurality of geolocations, or by identifying base stations of the PLMN at the location of the SNPN. In general, the location identified to the PLMN may be indicative of the SNPN's coverage area.

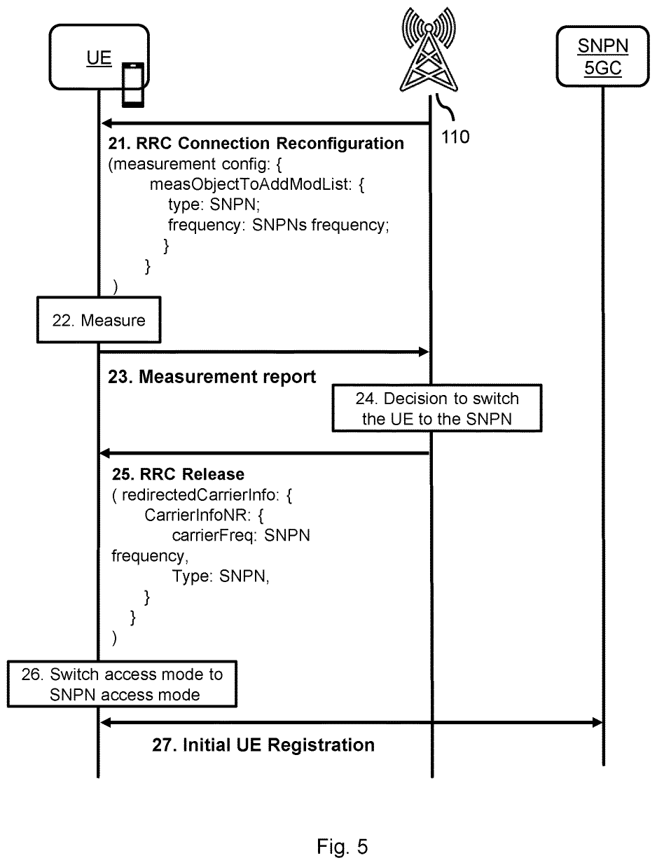

FIG. 5 shows a message exchange in the active phase. The message exchange in FIG. 5 may involve the following steps, which are described for one gNB of the PLMN but may equally apply to a group of gNB's:
21. The PLMN's gNB 110 may send a RRC Connection Reconfiguration message to the UE containing a measurement object. This relates to the following: at the start time for redirecting UEs (e.g., time_start as defined in step 21 in the provisioning phase, or immediately if such a parameter is not specified), the provisioned information in the PLMN's gNB (e.g., the frequencies used by the SNPN's gNBs) may be sent to the UEs that are in the gNB's range. This RRC Connection Reconfiguration message may instruct the UEs to measure the specified frequency for active cells. Moreover, the gNB may specify the type of measurement object as a SNPN cell. After receiving the measurement object, the UE may consider the discovered SNPNs as a candidate for future use (instead of as not suitable as it may be by default in the PLMN access mode, see 3GPP TS 38.304 Clause 4.5).
22. The UE may perform the specified measurements, and any other measurements specified in the previous RRC connection reconfiguration messages (e.g., of other neighboring cells around the current serving cell).
23. The UE may send a measurement report to PLMN's gNB 110. This report may, for example. include the measurements pertaining to the SNPN's current serving cell(s) and other neighboring cells that the UE measured.
24. The PLMNs gNB 110 may decide to switch the UE to the SNPN. For that purpose, the PLMNs gNB 100 may first, upon receiving the measurement report of the SNPNs cell(s), determine if the UE should be switched to the SNPN. There are multiple parameters the gNB may use to make this decision, such as the difference in the signal strength between the served and neighboring (SNPN) cell(s), the signal strength of the SNPN cell(s), the number of UE that the gNB already switched to the SNPN, the location of the UE, and/or the subscription preferences of the UE, etc.
25. The PLMNs gNB 110 may send a RRC Release message to the UE if the PLMN decides to switch the UE to the SNPN. This RRC Release message may include a Redirect configuration that specifies that the new cell, to which the UE should connect, belongs to an SNPN.
26. The UE may, in response to the RRC Release message, switch access mode from an PLMN access mode to an SNPN access mode.
27. The UE may register with the SNPN.

After the UE goes out of range of the SNPN, the UE may again switch access mode to the PLMN access mode and reconnect to the PLMN. Alternatively, a further RRC Release message may be used to redirect the UE back to the PLMN again, e.g., in the same manner as when redirecting the UE to the SNPN. In general, a temporary or semi-permanent SNPN may ensure that all the UE were properly released (and optionally redirected to the PLMN) before deciding to enter the cleanup phase.

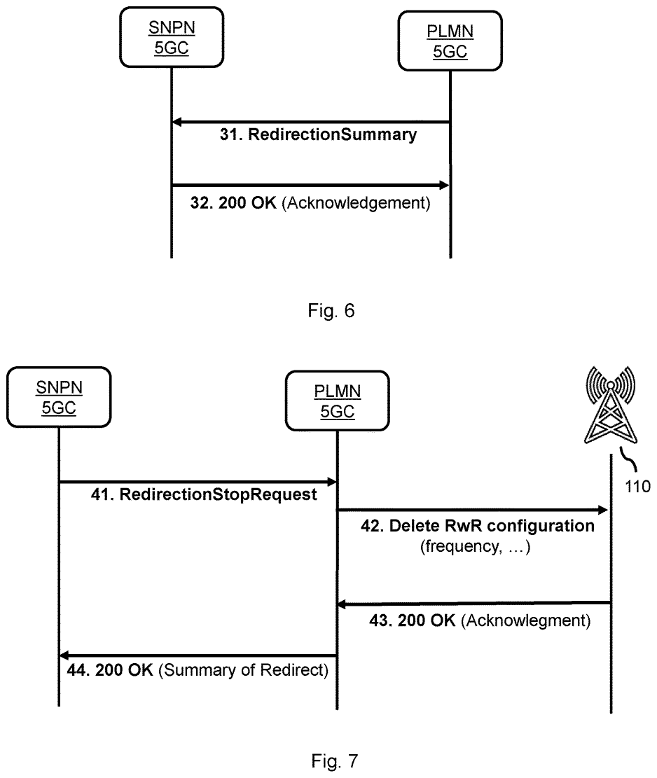

FIG. 6 shows a message exchange in the reporting phase. The reporting phase may be used to send periodic summaries from the PLMN to the SNPN and/or from the SNPN to the PLMN. This phase may be optional, and whether the reporting may be performed, and if so, which type of reporting is performed and how often, may be agreed upon in the provisioning phase. The message exchange in FIG. 6 shows the reporting from the PLMN's core to the SNPN's core but may apply mutatis mutandis to the reporting from the SNPN's core to the PLMN's core. The involved steps may be:
31. The PLMN's 5GC may send a RedirectionSummary to the SNPN's 5GC.

This summary may, for example, include a number of redirected UEs, a duration of the redirects, and charging information associated with the redirection of the UEs by the PLMN.
32. The SNPN's 5GC may respond with a 200 OK (Acknowledgement) message to the PLMN's Redirection Summary.

An alternative to steps 31, 32 of FIG. 6 is that in step 31, the SNPN's 5GC may send a request for reporting to the PLMN's 5GC, and in step 32, the PLMN's 5GC may respond with a 200 OK (Summary of Redirect) message to the SNPN's request, with the 200 OK message containing the report, e.g., the summary of redirects.

FIG. 7 shows a message exchange in the cleanup phase. The cleanup phase may only, or primarily, be applicable to temporary and semi-permanent SNPNs, such as a SNPN setup for a specific venue or a specific event. Permanent SNPNs, such as a SNPN in a museum or enterprise, may typically not require a cleanup phase. The message exchange in FIG. 7 may involve the following steps:
41. The SNPN's 5GC may send a RedirectionStopRequest message to the PLMN's 5GC. With this message, the SNPN may inform the PLMN that the SNPN will stop its operations. This may be due to, for example, an event that was serviced by the SNPN ending. Alternatively, the PLMN's 5GC may decide to stop redirection without being requested to do so by the SNPN's 5GC, for example, when the PLMN made use of the SNPN to temporarily offload (some of) its UE and such offloading is not needed anymore. In such a case, the PLMN's 5GC may send a message to the SNPN's 5GC to inform the SNPN that the PLMN will stop redirection of its UE to the SNPN.
42. The PLMN's 5GC may send an instruction to the PLMN's gNBs 110 to delete the Release with Redirect (RwR) configuration that was deployed to the PLMN's gNBs 110 in step 23 of the provisioning phase.
43. The PLMN's gNBs 110 may send a 200 OK (Acknowledgment) message to PLMN's 5GC when the delete request is completed.
44. The PLMN's 5GC may send a 200 OK (Summary of Redirect) message to the SNPN's 5GC after all the delete requests are completed. This summary may, for example, include a number of redirected UE, a duration of the redirects or charging information associated with the redirection.

In addition, after the SNPN stops its operations, the UE that were still attached to the SNPN's gNB may switch access modes to a PLMN access mode and reconnect to the PLMN.

The following continues to refer to the phases indicated in FIG. 3 but describes various steps from the perspective of a respective entity (e.g., UE, SNPN, PLMN, etc.) while referring to the respective phases. It is noted that the numbering of steps is here independent of the numbering used in the figures.

User equipment: the UE may perform one or more of the following steps:
1. (Active phase) Connect to the PLMN.
2. (Active phase) Receive and process the RRC Reconfiguration message (step 1 of the active phase). In contrast to the typical measurement configuration messages, this message may specify that the new cell is a SNPN cell. The UE may be configured to process this information and may categorize the cell as suitable and as a candidate for future use, if the cell is within the UE's range.
3. (Active phase) Perform measurements.
   a. If the UE measures a SNPN cell received in step 2, the UE may consider the cell as a valid candidate.
4. (Active phase) Upon detecting that the signal strength of the SNPN is higher than a specific threshold, e.g., a threshold received in the previous step or otherwise known to the UE, the UE may send a measurement report to the PLMN's gNB.
5. (Active phase) Upon receiving a RRC Release message with the redirect configuration with the SNPN indicator and referring to the SNPN cell referenced in the measurement report, the UE may be configured to process this information and may:
   a. Save the PLMNID of the PLMN to which the UE is currently connected.
   b. Change its access mode to SNPN access mode.
   c. Connect to the SNPN.
   d. Consume the service.
   e. If the SNPN has more than one active cell, the UE (since it is operating in an SNPN access mode) may see these other SNPN cells as valid candidates to switch to and/or the SNPN may perform a handover of the UE to another one of its active cells.

It is noted that, alternatively, the decision to switch to the SNPN access mode and/or the decision to connect to the SNPN may be offloaded to the UE instead of being instructed to do so via the RRC Release message. Namely, after performing measurements in step 3, the UE may already be aware that the cell at the specified frequency is an SNPN cell since it already measured the cell and can read broadcast messages about the cell containing information identifying the cell as an SNPN cell.
6. (Active phase) If the SNPN stops its operation (e.g., in case of temporary events) or the UE goes out of the coverage of the SNPN (e.g., a user leaving the venue), the UE may:
   a. Disconnect from the SNPN.
   b. Change its access mode to PLMN access mode. For that purpose, the UE may be configured so that the RRC Release with SNPN redirect configuration is only valid temporarily and only for the connection to the particular SNPN. Accordingly, upon disconnecting from the SNPN, the UE may resume its connection to the PLMN and may only be redirected to a new SNPN if the UE receives a new redirect instruction from the PLMN.
   c. Connect to the PLMN whose ID was saved in step 5.

SNPN: the SNPN may perform one or more of the following steps:
1. (Provisioning phase) The SNPN may inform one or more PLMNs of its PLMNID+NID, capabilities, the location, the timespan (e.g., time_start and time_stop) and potential QoS and/or network slices the SNPN can offer to the UE.
2. (Provisioning phase) Upon receiving the response from the PLMN(s), the SNPN may do one of the following:
   a. If the response of the PLMN is that it wishes to satisfy the request from the SNPN, meaning that the PLMN may have returned a 200 OK message to the SNPN, the SNPN may continue to step 3.
   b. If the response of the PLMN is that it does not wish to satisfy the request from the SNPN, meaning that the PLMN may have informed the SNPN thereof, the SNPN may stop this procedure.
3. (Provisioning phase) The SNPN may send information about its gNBs configuration to the PLMN, for example in form of frequency information and optionally location information indicating the gNB's locations.
4. (Provisioning phase) Upon receiving a confirmation that the gNBs were provisioned, the SNPN may be ready to start serving the UE.
5. (Active phase) The UE may connect to the SNPN and the SNPN may serve the connected UE.
6. [optional] (Reporting phase) The SNPN may receive redirect summaries from the PLMN, for example in response to a request sent from the SNPN to the PLMN. The SNPN may optionally send its own redirect summary to the PLMN.
7. (Cleanup phase) The SNPN may stop its operation, for example after an event is finished. The UE may be disconnected.
8. [optional] (Cleanup phase) The SNPN may inform the PLMN that it is no longer operational. This may also be previously indicated in form of the time_stop parameter sent in step 1.
9. [optional] (Cleanup phase) The SNPN may receive the summary of the redirects from the PLMN. This step may depend on a business agreement between the SNPN and the PLMN.

PLMN: the PLMN may perform one or more of the following steps:
1. (Provisioning phase) Upon receiving the request of the SNPN to redirect a number of its UE to the SNPN at a given location and optionally for a given time period, the PLMN may check if the PLMN can and wishes (e.g., subject to a business agreement existing between the PLMN's and the NPN's operators) to satisfy this request. Two options are possible:
   a. The PLMN wishes to satisfy the request and returns a 200 OK message to the SNPN. The procedure continues with step 2.
   b. If the PLMN does not wish to satisfy the request from the SNPN, the PLMN will inform the SNPN. This action may stop this procedure.
2. (Provisioning phase) Upon receiving the list of SNPN's gNBs configuration (e.g., used frequencies), the PLMN may:
   a. Determine the PLMN's gNBs that are at or in the vicinity of the location at which the SNPN wishes to service UE.
   b. For each of the determined gNBs, the PLMN may provisions the frequencies that will be used in the Measurement and Release with Redirect (RwR) steps of the active phase. Additionally, the PLMN may specify the period in time this configuration should be applied, e.g., with a time_start and time_stop parameter. If no period in time is provisioned, and in particularly if no time_start is provided, the configuration may be applied immediately.
   c. Upon provisioning the gNBs, the PLMN may return an Acknowledgment message to the SNPN informing the SNPN that it is ready to start redirecting UE.
3. (Active phase) At the specified moment in time (e.g., as specified by time_start), the SNPN may start its operation and the PLMN may send the RRC Reconfiguration message to all the UE in its area. This message may update the measurement configuration of the UE with the new SNPN cell(s).
4. (Active phase) Upon receiving the measurement report from the UE, the PLMN may send the RRC Release message with the SNPN redirect configuration to the UE. As a result, the UE may switch to the SNPN.
5. [optional] (Reporting phase) The PLMN may send a redirect summary, for example periodically, to the SNPN, for example in response to a request received from the SNPN. In some examples, the redirect summary may include information that may be used by the SNPN to estimate the costs, e.g., technical and/or financial, of the redirection.
6. (Cleanup phase) After the SNPN stops operation of its network, e.g., after an event is finished, the UE that were redirected to the SNPN may connect to the PLMN. The PLMN may continue servicing these UE.
7. [optional] (Cleanup phase) After the SNPN informs the PLMN that it is no longer operational, the PLMN may send the summary of the redirects from the PLMN to the SNPN. This step might depend on a business agreement existing between the SNPN and the PLMN.

It will be appreciated that the redirection of a UE from a PLMN to a SNPN may also take various other forms.

For example, instead of the SNPN requesting the PLMN to redirect UE, the PLMN may also request the SNPN to take over (a part of) its UE, e.g., to obtain additional coverage at a very busy event. In this case, messages 11 and 12 in the provisioning phase may be sent in the opposite direction compared to what is shown in FIG. 4. More specifically, the PLMN may send the RedirectRequest to the SNPN and the SNPN may acknowledge the request. Next, the SNPN may send the gNB information to the PLMN to ensure that the UE can be redirected to its gNBs. Moreover, in this case, in the cleanup phase, an additional redirectionSummary may be send from the SNPN to the PLMN highlighting the resources its UE consumed while being connected to the SNPN, which information may be used for, e.g., charging.

In general, the RRC Release message sent during the active phase might not need to include (all) the information that the UE needs to connect to an SNPN network. Namely, the UE may already be able to obtain this information from the measurement config that was sent by the gNB and the received broadcast messages. It is further noted that in the provisioning phase, the SNPN may request redirection of only a certain set of UE, for example, those that have an active subscription (e.g., a museum subscription, a sports subscription). The SNPN may also request that only certain UE be redirected to the SNPN. This may, for example, apply to scenarios where users need to subscribe in advance, e.g., to an event, venue, workshop, or conference, and fill in their phone numbers or provide another form of identification. This way, the PLMN may only redirect the selected UE to the SNPN.

In general, the functionality described in this specification, which is attributed to a system, may represent functionality of one or more network functions which are implemented in the mobile network, e.g., by a network node or a system of network nodes. The network function(s) may be made available within the respective mobile network so as to establish the respective functionality in this mobile network.

It will be appreciated that according to prior art standards (3GPP TS 23.501 Clause 5.30.2.4.1, 3GPP TS 23.122 Clause 4.4.1), SNPN and PLMN access modes in a UE may be mutually exclusive. Hence, a UE operating in SNPN access mode may select stand-alone Non-Public Networks (SNPNs) over the Uu interface and may not perform the PLMN selection process. Similarly, if a UE is not set to operate in SNPN access mode, even if it is SNPN-enabled, the UE may not select and register with SNPNs. The same reasoning may apply to PLMN access mode, e.g., a UE operating in PLMN access mode may not select and register with SNPNs, but only to available PLMNs. As a consequence, while a prior art UE (operating in SNPN mode and registered to an SNPN) may register with a PLMN via the SNPN (where the SNPN is acting as an Untrusted non-3GPP access, 3GPP TS 23.501 Clause 5.30.2.7), the UE may not switch to the PLMNs NG-RAN if out of range of the SNPN since the UE may be operating in the SNPN access mode. To address this deficiency, the UE may be instructed to switch access mode, e.g., in message 25 and step 26 as described with reference to FIG. 5 or may be configured to autonomously switch access mode if the measurement (e.g., step 22 in FIG. 5) indicates that a switch to the SNPN is possible. In the latter case, the measurement object specifying the SNPN type may cause the UE to later switch to SNPN access mode if the measurements are satisfactory. In particular, in the message containing the measurement object, one or more signal strength thresholds may be included, for example as part of a report object such as a reportConfig ToAddModList. The signal strength thresholds may conventionally be used to define conditions for when the UE is to send measurement reports to the network. However, in some embodiments, these signal strength thresholds may be used by the UE for a different purpose, namely, to determine when to switch to the SNPN access mode and subsequently connect to the SNPN. This may involve the UE comparing the measured signal strength against a signal strength threshold and proceeding to switch to the SNPN access mode if the measured signal strength exceeds the threshold.

FIG. 8 shows a processor system 400, which may represent a system for redirecting user equipment from a public mobile network to a non-public mobile network as described in this specification, meaning that the processor system 400 may implement such a system. The processor system 400 may comprise a network interface 410 for network data communication. The network interface 410 may, for example, be a wired communication interface, such as an Ethernet or fiber-optic based interface, to a fixed (e.g., non-mobile) part of a mobile telecommunications network. Alternatively, the network interface 410 may be a wireless communication interface. In yet other examples, the processor system 400 may be a subsystem of a larger system, e.g., a supra-system implementing several network functions. In such cases, the network interface 410 may be an internal interface of the supra-system, for example a virtual, software-based network interface.

The processor system 400 may further comprise a processor subsystem 420, which may be configured, e.g., by hardware design or software, to perform the operations described in this specification in as far as pertaining to the entity that the processor system is embodying, e.g., a system for redirecting user equipment from a public mobile network to a non-public mobile network. In general, the processor subsystem 420 may be embodied by a single Central Processing Unit (CPU), such as a x86 or ARM-based CPU, but also by a combination or system of such CPUs and/or other types of processing units. In embodiments where the processor system 400 is distributed over different entities, e.g., over different servers, the processor subsystem 420 may also be distributed, e.g., over the CPUs of such different servers. As also shown in FIG. 8, the processor system 400 may comprise a data storage 430, such as a hard drive, a solid-state drive, or an array of such hard and/or solid-state drives, etc., which may be used to store data. In some examples, the processor system 400 may be implemented by a network node, or by a system of network nodes jointly providing a network function.

In an alternative embodiment of the processor system 400 of FIG. 8, the processor system 400 may represent user equipment, or a device representing user equipment, as described in this specification. An example of such a device includes, but is not limited to, a mobile phone, tablet device, computer, smart glasses, a robotic system, a connectivity enabled vehicle, etc. In such cases, the network interface 410 may represent a radio access network interface to a mobile network, and the processor subsystem 420 may be configured, e.g., by hardware design or software, to perform the operations described in this specification in as far as pertaining to the entity that the processor system is embodying, e.g., the user equipment or the device.

In general, each entity described in this specification may be embodied as, or in, a device or apparatus. The device or apparatus may comprise one or more (micro)processors which execute appropriate software. The processor(s) of a respective entity may be embodied by one or more of these (micro)processors. Software implementing the functionality of a respective entity may have been downloaded and/or stored in a corresponding memory or memories, e.g., in volatile memory such as RAM or in non-volatile memory such as Flash. Alternatively, the processor(s) of a respective entity may be implemented in the device or apparatus in the form of programmable logic, e.g., as a Field-Programmable Gate Array (FPGA). Any input and/or output interfaces may be implemented by respective interfaces of the device or apparatus. In general, each functional unit of a respective entity may be implemented in the form of a circuit or circuitry. A respective entity may also be implemented in a distributed manner, e.g., involving different devices or apparatus.

It is noted that any of the methods described in this specification, for example in any of the claims, may be implemented on a computer as a computer implemented method, as dedicated hardware, or as a combination of both. Instructions for the computer, e.g., executable code, may be stored on a computer-readable medium 500 as for example shown in FIG. 9, e.g., in the form of a series 510 of machine-readable physical marks and/or as a series of elements having different electrical, e.g., magnetic, or optical properties or values. The executable code may be stored in a transitory or non-transitory manner. Examples of computer-readable mediums include memory devices, optical storage devices, integrated circuits, servers, online software, etc. FIG. 9 shows by way of example a memory card 500.

FIG. 10 is a block diagram illustrating an exemplary data processing system 1000 that may be used in the embodiments described in this specification. Such data processing systems include data processing entities described in this specification, including but not limited to a system for redirecting user equipment and a device representing user equipment. The data processing system 1000 may include at least one processor 1002 coupled to memory elements 1004 through a system bus 1006. As such, the data processing system may store program code within memory elements 1004. Furthermore, processor 1002 may execute the program code accessed from memory elements 1004 via system bus 1006. In one aspect, data processing system may be implemented as a computer that is suitable for storing and/or executing program code. It should be appreciated, however, that data processing system 1000 may be implemented in the form of any system including a processor and memory that is capable of performing the functions described within this specification. The memory elements 1004 may include one or more physical memory devices such as, for example, local memory 1008 and one or more bulk storage devices 1010. Local memory may refer to random access memory or other non-persistent memory device(s) generally used during actual execution of the program code. A bulk storage device may be implemented as a hard drive, solid state disk or other persistent data storage device. The data processing system 1000 may also include one or more cache memories (not shown) that provide temporary storage of at least some program code in order to reduce the number of times program code is otherwise retrieved from bulk storage device 1010 during execution.

Input/output (I/O) devices depicted as input device 1012 and output device 1014 optionally can be coupled to the data processing system. Examples of input devices may include, but are not limited to, for example, a microphone, a keyboard, a pointing device such as a mouse, a game controller, a Bluetooth controller, a VR controller, and a gesture-based input device, or the like. Examples of output devices may include, but are not limited to, for example, a monitor or display, speakers, or the like. Input device and/or output device may be coupled to data processing system either directly or through intervening I/O controllers. A network adapter 1016 may also be coupled to data processing system to enable it to become coupled to other systems, computer systems, remote network devices, and/or remote storage devices through intervening non-public or public networks. The network adapter may comprise a data receiver for receiving data that is transmitted by said systems, devices and/or networks to said data and a data transmitter for transmitting data to said systems, devices and/or networks. Radios, modems, cable modems, and ethernet cards are examples of different types of network adapter that may be used with data processing system 1000.

As shown in FIG. 10, memory elements 1004 may store an application 1018. It should be appreciated that data processing system 1000 may further execute an operating system (not shown) that can facilitate execution of the application. The application, being implemented in the form of executable program code, can be executed by data processing system 1000, e.g., by processor 1002. Responsive to executing the application, the data processing system may be configured to perform one or more operations to be described herein in further detail.

For example, data processing system 1000 may represent a system for redirecting user equipment as described in this specification. In that case, application 1018 may represent an application that, when executed, configures data processing system 1000 to perform the functions described with reference to the system for redirecting user equipment. In another example, data processing system 1000 may represent an embodiment of user equipment or a device representing user equipment as described in this specification. In that case, application 1018 may represent an application that, when executed, configures data processing system 1000 to perform the functions described with reference to the user equipment and/or device.

An abstract for the present specification may read as follows: a first system may be provided in a public mobile network and a second system may be provided in a non-public mobile network, which systems may cooperate to selectively redirect user equipment from the public mobile network to the non-public mobile network. Such redirection may be implemented by the first system instructing base station(s) within the coverage area or vicinity of the non-public mobile network to in turn instruct user equipment to perform measurements at radio frequencies used by the non-public mobile network. This way, user equipment may be instructed to listened for the radio frequencies used by the non-public mobile network, and if the user equipment is in the coverage area of the non-public mobile network, the user equipment may switch and connect to the non-public mobile network and thereby benefit from enhanced services and/or additional coverage. Advantageously, it may not be needed for the user to manually search for the non-public mobile network, nor for the user equipment to be already provisioned for the non-public mobile network.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or stages other than those stated in a claim. The article “a” or “an” preceding an element does not exclude the presence of a plurality of such elements. Expressions such as “at least one of” when preceding a list or group of elements represent a selection of all or of any subset of elements from the list or group. For example, the expression, “at least one of A, B, and C” should be understood as including only A, only B, only C, both A and B, both A and C, both B and C, or all of A, B, and C. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for redirecting user equipment from a public mobile network to a non-public mobile network, wherein the system is part of the public mobile network, wherein the system comprises:
a network interface;
a processor subsystem configured to, via the network interface:
receive a request to redirect user equipment from the public mobile network to the non-public mobile network, wherein the request identifies the non-public mobile network;
receive location information which is indicative of a coverage area of the non-public mobile network;
receive frequency information which is indicative of one or more radio frequencies used by the non-public mobile network;
identify at least one base station of the public mobile network which is located in or within a range of the coverage area of the non-public mobile network; and
using the at least one base station of the public mobile network, instruct user equipment which is connected to the at least one base station to perform measurements at the one or more radio frequencies so as to enable the user equipment to connect to the non-public mobile network if the measurements indicate that a connection to the non-public mobile network is possible.

2. The system according to claim 1, wherein the processor subsystem is configured to, using the at least one base station:
receive measurement data from the user equipment, wherein the measurement data comprises the measurements performed by the user equipment;
analyze the measurements to determine if the connection to the non-public mobile network is possible, and if so, instruct the user equipment to connect to the non-public mobile network.

3. The system according to claim 1, wherein the processor subsystem is configured to, using the at least one base station, instruct the user equipment to switch to an access mode for connecting to the non-public mobile network if the measurements indicate that the connection to the non-public mobile network is possible.

4. The system according to claim 1, wherein the processor subsystem is configured to receive time information which is indicative of a start time at which the user equipment is to be redirected to the non-public mobile network, and instruct the user equipment at the start time or at a time which is selected based on the start time.

5. The system according to claim 1, wherein the processor subsystem is configured to instruct the user equipment using the at least one base station by provisioning the at least one base station to send corresponding instructions to the user equipment.

6. The system according to claim 5, wherein the provisioning comprises sending at least the frequency information to the at least one base station to enable the at least one base station to instruct the user equipment to perform the measurements at the one or more radio frequencies.

7. The system according to claim 5, wherein the processor subsystem is configured to, in response to a request to stop redirecting the user equipment to the non-public mobile network, provision the at least one base station to stop sending instructions to the user equipment.

8. A system for redirecting user equipment from a public mobile network to a non-public mobile network, wherein the system is part of the non-public mobile network, wherein the system comprises:
a network interface;
a processor subsystem configured to, via the network interface:
send a request to the public mobile network to redirect user equipment from to the public mobile network to the non-public mobile network, wherein the request identifies the non-public mobile network;
send location information to the public mobile network, wherein the location information is indicative of a coverage area of the non-public mobile network; and
send frequency information to the public mobile network, wherein the frequency information is indicative of one or more radio frequencies used by the non-public mobile network.

9. The system according to claim 8, wherein the processor subsystem is configured to send one or more of a group of:
a start time at which the user equipment is to be redirected to the non-public mobile network, a stop time after which the user equipment is not to be redirected to the non-public mobile network,
a reporting interval indicating at which interval the public mobile network is to report on redirection of the user equipment,
a reporting type indicating a type of the reporting,
identification information identifying a group of user equipment which is to be redirected to the non-public mobile network,
to the public mobile network.

10. A mobile network comprising the system according to claim 1.

11. A device representing user equipment for a mobile network, wherein the device comprises:
a radio access network interface;
a processor subsystem configured to, when connected to a public mobile network:
receive a request to perform measurements at one or more radio frequencies used by a non-public mobile network, wherein the one or more radio frequencies are indicated by frequency information, wherein the frequency information is received:
in response to the request, perform the measurements; and
connect to the non-public mobile if the measurements indicate that a connection to the non-public mobile network is possible.

12. The device according to claim 11, wherein the processor subsystem is configured to, before connecting to the non-public mobile network, switch to an access mode for connecting to the non-public mobile network, for example in response to an instruction received from the public mobile network.

13. The device according to claim 12, wherein the processor subsystem is configured to, after disconnecting from the non-public mobile network, switch to an access mode for connecting to the public mobile network.

14. The device according to claim 11, wherein the processor subsystem is configured to:
send the measurements to the public mobile network; and
connect to the non-public mobile network in response to a request from the public mobile network to connect to the non-public mobile network.

15. The device according to claim 11, wherein the processor subsystem is configured to analyze the measurements to determine if the connection to the non-public mobile network is possible, and if so, connect to the non-public mobile network.

16. A computer-implemented method for redirecting user equipment from a public mobile network to a non-public mobile network, wherein the method comprises, at the public mobile network:
receiving a request to redirect user equipment from the public mobile network to the non-public mobile network, wherein the request identifies the non-public mobile network;
receiving location information which is indicative of a coverage area of the non-public mobile network;
receiving frequency information which is indicative of one or more radio frequencies used by the non-public mobile network;
identifying at least one base station of the public mobile network which is located in or within a range of the coverage area of the non-public mobile network; and
using the at least one base station of the public mobile network, instructing user equipment which is connected to the at least one base station to perform measurements at the one or more radio frequencies so as to enable the device to connect to the non-public mobile network if the measurements indicate that a connection to the non-public mobile network is possible.

17. A computer-implemented method for redirecting user equipment from a public mobile network to a non-public mobile network, wherein the method comprises, at the non-public mobile network:
sending a request to the public mobile network to redirect user equipment from to the public mobile network to the non-public mobile network, wherein the request identifies the non-public mobile network;
sending location information to the public mobile network, wherein the location information is indicative of a coverage area of the non-public mobile network; and
sending frequency information to the public mobile network, wherein the frequency information is indicative of one or more radio frequencies used by the non-public mobile network.

18. A computer-implemented method for being performed by a device which represents user equipment of a public mobile network, wherein the method comprises, by the device:
receiving a request to perform measurements at one or more radio frequencies used by a non-public mobile network, wherein the one or more radio frequencies are indicated by frequency information, wherein the frequency information is provided as part of the request or separately;
in response to the request, performing the measurements; and
connecting to the non-public mobile if the measurements indicate that a connection to the non-public mobile network is possible.

19. A non-transitory computer-readable medium comprising data representing a computer program, the computer program comprising instructions for causing a processor system to perform the method according to claim 16.
